(19) United States
(12) Patent Application Publication
(10) Pub. No.: US 2022/0356611 A1
(43) Pub. Date: Nov. 10, 2022

(54) DEVICE FOR CREATING A 3D PREFORM, 3D PRODUCTION METHOD USING SAID DEVICE AND 3D PREFORM THUS OBTAINED

(71) Applicant: 3DITEX, Merignac (FR)

(72) Inventors: Bertrand Laine, Saint Aubin De Medoc (FR); Aymeric Azran, Blagnac (FR)

(21) Appl. No.: 17/624,157

(22) PCT Filed: Jul. 3, 2020
(86) PCT No.: PCT/EP2020/068811

§ 371 Date: Dec. 30, 2021

(30) Foreign Application Priority Data
Jul. 3, 2019 (FR) FR1907418

(51) Int. Cl. D03D 25/00; B29B 11/16; D03D 41/00; D03D 15/46; D03D 47/34

(52) U.S. Cl. CPC D03D 25/005; B29B 11/16; D03D 41/008; D03D 41/004; D03D 15/46; D03D 47/34; B29K 2105/0845

(57) ABSTRACT

Device for producing a preform to a given 3D profile, from at least two warp tapes/filaments (18) placed in a first plane and at least one weft tape/filament (20) placed in a second plane, the first and second planes making a determined angle, characterized in that it comprises feed means (12) for warp tapes/filaments (18) with independent modules, feed means (14) for weft tapes/filaments (20), manoeuvring _{[GH19]} means (16) for manoeuvring the warp tapes/filaments (18) with respect to the weft tapes/filaments (20), and manoeuvring means (16) for manoeuvring all of the warp tapes/filaments (20), according to said given 3D profile.

The invention relates to a device for producing a 3D preform, in particular from tapes or filaments. The invention also relates to a method for producing a 3D preform starting from the device according to the invention, in particular for the manufacture of parts from composite materials. The invention also relates to the 3D preform thus obtained.

The demand for 3D composite material parts is growing, and the production remains complex. However, the series are often series having a restricted number of parts, and writing a software and the use of complex and expensive machines still cannot be envisaged for small series. Moreover, the composite material parts are becoming more and more complex because they aim to no longer integrate only filaments, but also tapes, conductor filaments, and the current machines cannot work with the defined lengths of filaments or of tapes so as to obtain a 3D preform of given dimensions, suitable for being used directly on a tool for producing a composite material. Another point of interest is also that of being able to integrate tapes of synthetic polymer materials, but also woven, plaited or metal tapes or filaments. For example, it may be of interest to target a part in which tapes of conductive materials are integrated, for the purpose of heating or for information flow. However, for some complex composite parts, the draping of a fabric is in no way suitable, or indeed is impossible, when the shapes are complex. It would be necessary to be able to have a 3D framework, having the exact profile of the tool for producing the composite material product or which can at least be shaped in order to drape in an optimal manner without distending said preform. It must be possible, either proceeding from a 3D preform having the final profile, or proceeding from a 3D preform which will then _{[GH1][AH2]} definitively formed on a suitable tool and submerged in a resin matrix in order to produce the material composite part in the shape sought, but having a perfect repetition of the tapes/filaments. Indeed, a woven 2D part which is intended to be draped necessarily exhibits a disparity of the density of the tapes/filaments during the forming, since the variations in length caused by the curvatures prevents a uniform distribution of said tapes/filaments. Said uniform distribution must be achieved in both directions, i.e. according to the weft filaments and the warp filaments.

On-demand manufacture, in a single copy, is even more sought-after when it is a case of being able to perform tests of prototype parts for example. The present device aims to propose, for a user, a device for weaving a 3D preform in the same way as a 3D printer, making it possible to produce a composite material part using a tool intended for receiving said preform, all on demand.

The prior art is illustrated by the document DE 3 915 085 which discloses an arrangement which leads to the production of a 3D preform from a constant number of filaments, and the shape is generated by putting into place a preform on the profile of the part to be adjusted, on which filaments are deposited which are woven in a known manner by a Jacquard weaving machine for example. The warp filaments are thus spaced further apart on the surface of the part, and are distended. The mesh size is clearly larger, which is normal on account of the constant number of filaments which are merely stretched out, but the number is not increased. The warp filaments are displaced alternately, in a known manner, in order to achieve the weaving and the introduction of the weft filaments. For the forming, a support is provided having the profile of the part to be produced, which is introduced in the form of blocks as the advancement takes place. It is thus necessary to produce a preform having the profile of each part to be produced. In order to overcome this disadvantage, the support on which the filaments are deposited can also be obtained from flexible blades provided with actuators on which the filaments are arranged. Thus, the support gradually lifts the filaments. The filaments are guided by guides of a known time, during said weaving operation. Moreover, no additional filament can be introduced in order to compensate the reduction in the density of filaments generated by the 3D shape. It is observed that the device operates _{[GH3][AH4]} horizontally, which is required by said preform, and that the warp filaments are worked in two layers, in a known manner, and not

Another prior art document also proposes weaving proceeding from shaped weft filaments having a uniform distribution of the warp filaments with respect to the shaped weft filaments. A device of this kind does not comprise a shaped support, in contrast with the first document, but the supports for introduction and guidance of each of the warp filaments are not individual and cannot be fed independently and in a manner having a given length. The density cannot be compensated either in weft or in warp.

The device for producing a preform according to a given 3D profile, from at least two warp tapes/filaments arranged in a first plane and at least one weft tape/filament arranged in a second plane, the first and second planes making a determined angle, is characterized in that it comprises feed means for feeding warp tapes/filaments with independent modules, feed means for weft tapes/filaments, maneuvering means for maneuvering the warp tapes/filaments with respect to the weft tapes/filaments, and maneuvering means for maneuvering all of the warp tapes/filaments and of the weft tapes/filaments, according to said given 3D profile. The feed means for feeding warp tapes/filaments comprise modules for translational displacement of the warp tapes/filaments. The feed means for feeding warp tapes/filaments comprise forming modules for said warp tapes/filaments. The forming modules each comprise a guide through which one of the at least two warp tapes/filaments passes, each guide being associated with two guide rails, arranged in the second plane of the weft tapes/filaments. Moreover, according to another feature, the guide rails can be shaped and comprise shaping means of said rails. With regard to the feed means for feeding the weft tapes/filaments, these comprise a set of two wheels which are motorized so as to cause a weft tape/filament to advance in the horizontal plane, said weft tape/filament being introduced between the two rails. According to an improvement, the device comprises means for point connection of the warp and weft tapes/filaments, at the intersection.

The invention relates to a method for producing a 3D preform by implementing the device according to any of the preceding claims, characterized in that it comprises the following steps:

arranging at least two warp tapes/filaments, in a first plane,

arranging at least one weft tape/filament in a second plane, perpendicular to the first plane, each tape/filament being introduced between the warp tapes/filaments,

guiding and displacing each warp tape/filament over a given length in the first plane, and according to a given profile of the warp tapes/filaments, in the second plane,

guiding and displacing each weft tape/filament, in the second plane, over a given length following said profile, between the warp tapes/filaments.

According to another feature of the method, one step consists in arranging the at least two warp tapes/filaments on either side of the given profile, alternately, having a passage between said warp tapes/filaments for introduction of at least one weft tape/filament between said at least two warp tapes/filaments. According to another variant, the method consists in ensuring the connection of the warp tapes/filaments and the weft tapes/filaments, as the warp tapes/filaments advance, according to the given profile.

More particularly, the invention relates to the 3D preform obtained by the production method, using the device, and said preform comprises warp tapes/filaments and weft tapes/filaments of different lengths, and at least one point connection between a warp tape/filament and a weft tape/filament.

The present invention will now be described with reference to examples, which are given merely by way of example and in no way limit the scope of the invention, and on the basis of the accompanying drawings, in which:

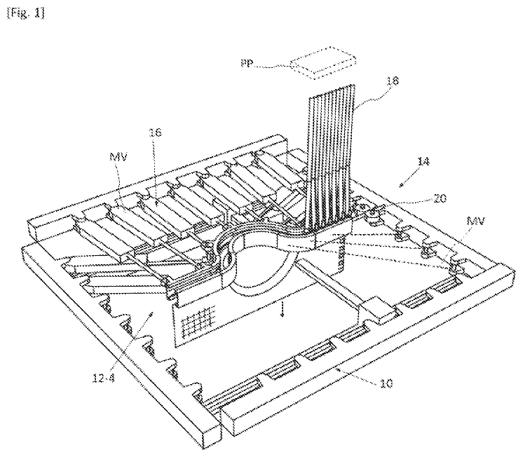

FIG. 1 is a simplified schematic perspective view of the 3D weaving device according to the present invention.

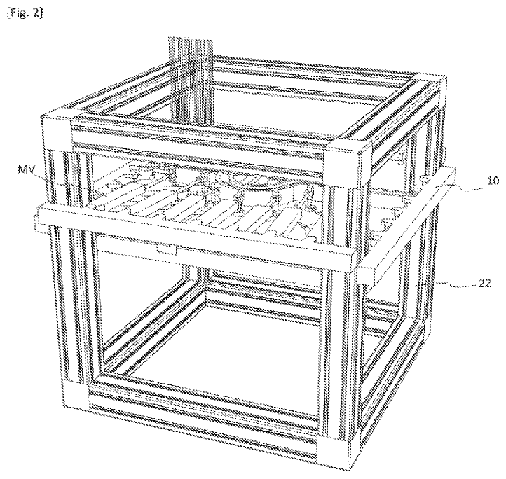

FIG. 2 is a schematic perspective view of the 3D weaving device according to the present invention.

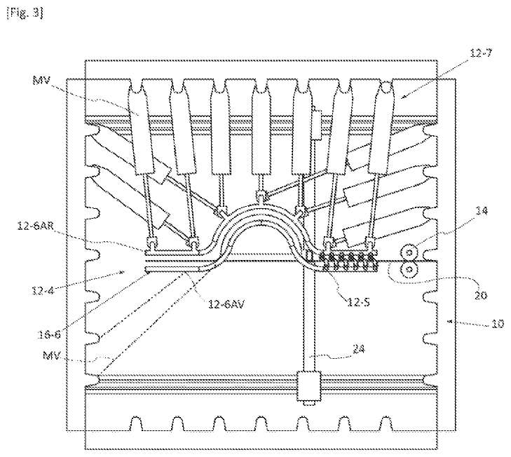

FIG. 3 is a schematic view from above of the device of FIG. 1.

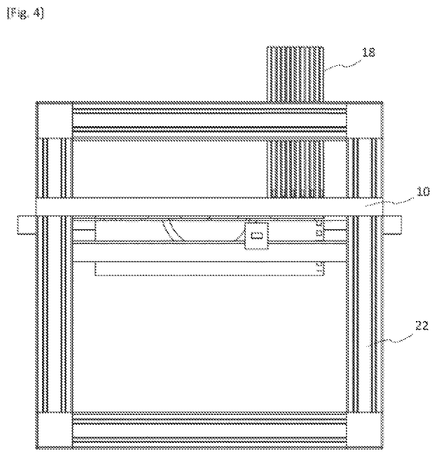

FIG. 4 is a front view, in lateral elevation, of the device of FIG. 1.

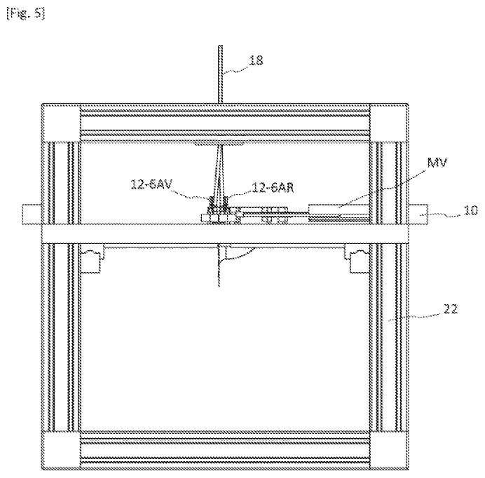

FIG. 5 is a side view, in lateral elevation, of the device of FIG. 1.

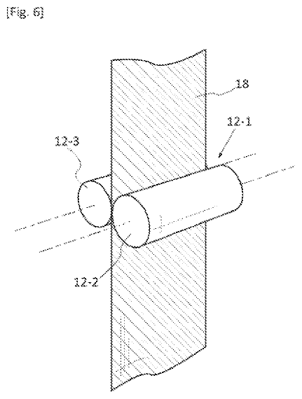

FIG. 6 shows an embodiment of a module for displacing a warp tape/filament.

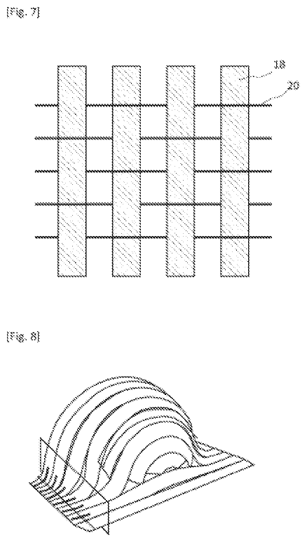

FIG. 7 is a schematic view of the weaving, with alternation of warp and weft tapes/filaments.

FIG. 8 is a schematic view of trajectories of the filaments/tapes according to a direction, warp or weft, with the aim of producing a 3D preform that is to be produced.

The following description relates to the weaving of a preform, i.e. a set of warp/weft, and an over/under passage of the warp and weft tapes/filaments. Nonetheless, the present application is already also directed to the production of a 3D preform by superposition of at least two layers, by extension at least one warp layer and one weft layer, having mechanical connections at the intersection points of the tapes/filaments, for example by means of fusion or by means of adhesive bonding.

The following description corresponds to an arrangement with a complete arrangement, i.e. having two rails, making it possible to produce 3D preforms in different configurations. Thus, the embodiment which will be described comprises two rails, but the device could comprise just one.

The device according to the present invention, illustrated in the various drawings, comprises a frame 10, feed means 12 for feeding warp tapes/filaments 18 and feed means 14 for feeding weft tapes/filaments 20, as well as maneuvering means 16 for maneuvering the warp tapes/filaments 18 with respect to the weft tapes/filaments 20. The assembly is arranged on a machine chassis 22.

The machine chassis 22 supports the frame 10 and the feed means 12 for feeding warp tapes/filaments 18, in the vertical direction. The 3D preform is thus subjected to its own weight. Said feed means 12 for feeding warp tapes/filaments 18 comprise modules 12-1 for translational displacement of the warp tapes/filaments 18, in this case a vertical displacement, visible in FIG. 6. Said modules 12-1 for translational displacement of the warp tapes/filaments 18 are independent and can be controlled individually. Light tension means (not shown) can be put in place at the lower ends of the warp tapes/filaments 18 during priming of the preform. Said modules 12-1 for translational displacement of the tapes/filaments are represented schematically by rollers 12-2 and 12-3 in FIG. 6. Each module 12-1 for translational displacement of the warp tapes/filaments 18 comprises for example two rollers 12-2 and 12-3, pressed against one another and caused to rotate by a micromotor (not shown), in an individualized manner, this type of driving being known _{[GH5][AH6]}. A programmable driver PP ensures the commands of said micromotors. A programmable driver PP of this kind causes the rollers 12-2 and 12-3 to be set into rotation, and thus the warp tape/filament 18, placed between said rollers, to be advanced, step by step, by a given length for each of the warp tapes/filaments 18.

In addition to the modules 12-1 for translational displacement of the warp tapes/filaments 18, the feed means 12 for feeding warp tapes/filaments 18 comprise forming modules 12-4 for said warp tapes/filaments 18. Said forming modules 12-4 each comprise a guide 12-5 through which one of the warp tapes/filaments 18 passes. Each guide 12-5 is associated with at least one guide rail 12-6, in this case two guide rails 12-6, which can be shaped, a front guide rail 12-6AV and a rear guide rail 12-6AR, arranged in the horizontal plane of the frame 10, i.e. in the plane of the weft tapes/filaments 20.

Feed means 14 for feeding weft tapes/filaments 20 between the two front 12-6AV and rear 12-6AR guide rails are also provided. Since said at least one guide rail 12-6 can be shaped, comprises shaping means 12-7 of the at least one rail. Said shaping means 12-7 comprise micro-actuators MV, in the embodiment retained. Said micro-actuators MV are rigidly connected, in each case by the piston thereof, to each of the rails, for example, while the body of each of said micro-actuators is rigidly connected to the chassis 10. Thus, the movement of each of the micro-actuators in each case displaces the guide rails 12-6 and positions them in the horizontal plane, in this case according to the profile sought, having one or more defined curvatures. The actuators can thus move the guide rails 12-6, individually or simultaneously. In the view in FIG. 1, a curve is shown, with the aim of producing the 3D preform of FIG. 8 for example. The two guide rails are parallel and spaced apart by a given gap, but can be moved closer or further apart, as needed. The guides 12-5 are associated with two rails, front 12-6AV or rear 12-6AR, electively, as needed. These guides 12-5, and thus the warp filaments which they guide, can thus be borne by one or other of the two front 12-6AV or rear 12-6AR guide rails. Temporary rigid connection means, for each of the guides 12-5, for example electromagnets (not shown), which are rigidly connected to the two rails, can retain the guides 12-5 against one rail or against the other, and ensure a displacement from one rail to the other. In order to arrive at a weave, it is necessary, in fact, for the first guide 12-5, together with the warp tape/filament 18 thereof, to be able to be alternately on the rear rail 16-6AR and then on the front rail 16-6AV, the second guide 12-5 which is juxtaposed with respect thereto being itself on the rail opposite that of the first guide. In the same way, the alternation may be every two guides, the selection of the weave being programmable.

The weft feed means 14 comprise at least one set of two wheels 14-1 and 14-2 which are motorized so as to cause at least one weft tape/filament 20 to advance in a weft plane which forms a specified angle with respect to the plane containing the warp tapes/filaments 18. If the warp filaments/tapes are vertical, the weft filament/tape is introduced in a horizontal plane. Thus, the plane of introduction of the weft always forms an angle of 90° with respect to the plane of the warp tapes/filaments in the direction perpendicular to the warp filaments. However, the warp tapes/filaments may be inclined to a greater or lesser extent _{[GH7][AH8]} in the plane of the warp tapes/filaments. The weft tapes/filaments form an angle that varies from 1° to 179° with respect to the warp tapes/filaments. Said at least one weft tape/filament is introduced between the two rails 12-6, front 12-6AV and rear 12-6AR, i.e. between the guides 12-5 or between the warp filaments/tapes. Each weft tape/filament 20 is thus introduced between the warp tapes/filaments 18. The length of each weft tape/filament 20 is adjusted depending on the shape of the 3D preform to be produced, and thus adjusted so as to be able to follow the developed length of the rails when these have been curved to give a curved shape to the first plane or to achieve a partial introduction. Cutting means (not shown) ensure each weft tape/filament is cut to the suitable length. The front and rear guides 12-5 of the warp filaments/tapes, or the warp filaments/tapes themselves, ensure the guidance through the warp tapes/filaments, and thus the weaving.

According to an improvement of the device, point connections 24 for the warp and weft tapes/filaments are provided, on at least some intersection points, in this case at the intersection of the crossing points of the weaving. If the warp and weft tapes/filaments are made of materials that can be welded, said connections consist in welds and, according to a variant, material may be added or not. The connections can thus be depositions of glue dots, for example hot melt glue dots, on at least some intersections. The connections are formed to the right of the crossing points of the warp and weft tapes/filaments, so _{[GH9][AH10]} as to ensure maintenance, during the advancement and the guidance of the warp tapes/filaments, thus maintaining the given profile and the positioning of the filaments/tapes with respect to one another.

According to a variant, the at least one weft tapes/filaments 20 can be positioned in front of or behind the warp 18 filaments and can be directly interconnected, at the intersection points, and the connections can also be achieved by fusion welding and/or by addition of material, or indeed by deposition of glue dots. In the present description, a “point” or “dot” means the zones of coverage or superposition; thus, the point or dot can have a surface region, not necessarily a disk if the fusing heads are of different shapes or comprise spikes in order to form mulitipoints on an intersection zone, in particular if these are two tapes for example.

The method for producing a 3D preform, according to the present invention, provides the steps consisting in:

arranging at least two warp tapes/filaments 18, in a first plane,

arranging at least one weft tape/filament 20 in a second plane, said second plane forming a specified angle with respect to the first plane, each of the at least one weft tape/filament 20 being introduced between the warp tapes/filaments 18, or each of the at least one weft tape/filament 20 being superposed on the warp tapes/filaments 18,

guiding and displacing each warp tape/filament 18 over a given length in the first plane, and according to a given profile of the warp tapes/filaments 18,

guiding and displacing each weft tape/filament 20, in the second plane, according to the specified angle, over a given length following said profile defined by the warp filaments, between or on the warp tapes/filaments 18.

The method consists in arranging the at least two warp tapes/filaments 18 on either side of the given profile, _{[GH11][AH12]} alternately, creating a passage between said warp tapes/filaments for introduction of at least one weft tape/filament 20 between said at least two warp tapes/filaments 18.

The method also consists in arranging the connections, achieved by fusion welding and/or with addition of material, at least at some intersection points.

The method consists in arranging the at least two warp tapes/filaments 18, in the plane of the given profile, having a passage between said warp tapes/filaments for introduction of at least one weft tape/filament 20 between said at least two warp tapes/filaments 18.

The method consists in ensuring the connection of the warp tapes/filaments 18 and the weft tapes/filaments 20, as the warp tapes/filaments 18 advance, according to the given profile.

The method consists in calculating the length of the warp tapes/filaments and the length of the weft tapes/filaments, according to the profile of the 3D preform to be produced, so as to obtain a finished 3D preform. In this case, the method consists in forming at least the point connections at the periphery of said 3D preform, for the majority, and optionally at certain particular points. A 3D preform of this kind can thus be shaped after manufacture, by means of the device and method according to the invention, on a tool for manufacturing the composite material part intended to cover said 3D preform. The distribution of the warp and weft tapes/filaments is thus homogeneous, since the length has been calculated depending on the developed path of said manufacturing tool.

In the same way, it is understood that the modules 12-1 for translational displacement of the warp tapes/filaments 18 can initially be provided _{[GH13][AH14]} in excess, so as to be able to introduce, when necessary, an additional warp filament/tape of a given length, to compensate the density of the warp filaments, on account of the curvature which increases the final surface area. This is also true for the warp filaments/tapes which can be introduced over a given length, i.e. in the curved forms, in order to compensate the density of the weft tapes/filaments 20. Herein lies the interest of independent introduction modules for the warp filaments, and the guidance of the weft filaments of given length in a specified position with respect to the warp filaments. The density is thus preserved in all directions. The warp 20 and weft 18 tapes/filaments can also be different in nature, at points.

The device according to the present invention comprises shaping means which guide the warp tapes/filaments 18 according to a sought 3D profile, but simultaneously guides the weft tapes/filaments 20 which are associated according to this same 3D profile. This arrangement allows for great flexibility of manufacture, and for manufacture of 3D preforms which would be impossible to achieve using the devices of the prior art. The guidance which is both independent _{[GH15][AH16]} of the warp with respect to the weft, and common to the warp and weft at the same time, according to a given 3D profile, is the essence of the invention.

FIG. 7 shows trajectories of the filaments/tapes according to a direction, warp or weft, with the aim of producing a 3D preform that is to be produced, digitized, which makes it possible to determine the lengths of the warp tapes/filaments 18 and the weft tapes/filaments 20, according to their position. The digitized preform also makes it possible to determine the movements of the shaping means 12-7 to be brought about by the programmable driver PP. The present invention relates to the 3D preform obtained by the method, using the device and comprising warp tapes/filaments and weft tapes/filaments of different lengths, and at least one point connection between a warp tape/filament 18 and a weft tape/filament 20.

The shape of the preform is not necessarily that of the finished product, which will be shaped on the final tool during the manufacture of the composite material product. The lengths of each of the weft tapes/filaments are adjusted such that the preform covers the tool and has a homogeneous distribution of the tapes/fibers or is reinforced at points according to the zone.

According to a variant in location and position of the displacements from one rail to the other, the guides 12-5, instead of being displaced from one rail to the other, can be mounted in a tilting manner on one and the same rail. In this case, this one rail makes it possible to receive the various guides 12-5 in a tilting manner, in order to implement the weaving from either side of the weft filament/tape, the shaped rail making it possible to produce 3D shapes. In such a case, it is not possible to add warp filaments/tapes between the warp filaments/tapes already in place, because it is not possible to fetch guides 12-5 in reserve on the other rail, since just one rail is provided. In order to preserve the density of filaments/tapes, the addition of warp filaments/tapes remains entirely possible, but on the outside of the existing warp filaments/tapes, by positioning, pending, on the same rail, guides 12-5 which each have a warp filament/tape pending on the rail, on either side of the guides 12-5 already in place and used. This makes it possible to preserve the operating width, despite the 3D shape and thus the increase generated. It is thus expedient to bring closer the warp filaments/tapes and to add additional warp filaments/tapes on either side, depending on the requirements of the 3D part sought. The density can thus be constant, but the filaments are no longer rectilinear.

In order to add warp filaments and preserve the density of filaments/tapes over the entire 3D developed surface, or to carry out punctual densification, retaining the rectilinear filaments, it is necessary to have available two rails _{[GH17][AH18]}, as in the preferred embodiment described.

The guides 12-5 can also be mounted in a tilting manner on each of the two rails, and it is possible to introduce two weft filaments/tapes, one into the guides 12-5 of the first rail, and one into the guides 12-5 of the second rail, such that it is possible to weave a layer on each of the rails, in the shape sought, for example a sphere, and to form a planar layer on the periphery. The fact of controlling the guides 12-5 independently thus makes it possible to be able to produce a 3D preform having a planar layer in which a sphere is positioned, the entire assembly being monolithic.

1. A device for producing a preform according to a given 3D profile, from at least two warp tapes/filaments (18) arranged in a first plane and at least one weft tape/filament (20) arranged in a second plane, the first and second planes making a determined angle, characterized in that it comprises feed means (12) for feeding warp tapes/filaments (18) with independent forming modules (12-4) for said warp tapes/filaments (18), feed means (14) for weft tapes/filaments (20), maneuvering means (16) for maneuvering the warp tapes/filaments (18) with respect to the weft tapes/filaments (20), and maneuvering means (16) for maneuvering all of the warp tapes/filaments (18) and of the weft tapes/filaments (20), according to said given 3D profile.

2. The device for producing a 3D preform according to claim 1, characterized in that the forming modules (12-4) each comprise a guide (12-5) through which one of the at least two warp tapes/filaments (18) passes, each guide (12-5) being associated with at least one guide rail (12-6), arranged in the second plane of the weft tapes/filaments (20).

3. The device for producing a 3D preform according to claim 2, characterized in that the at least one guide rail (12-6) can be shaped, and comprises shaping means (12-7).

4. The device for producing a 3D preform according to claim 3, characterized in that the feed means (14) for feeding the weft tapes/filaments (20) comprise a set of two wheels (14-1, 14-2) which are motorized so as to cause a weft tape/filament (20) to advance in the horizontal plane, said weft tape/filament (20) being introduced between the two guide rails (12-6).

5. Device The device for producing a 3D preform according to any of the preceding claims, characterized in that it comprises point connection means (24) of the warp (18) and weft (20) tapes/filaments.

6. The device for producing a 3D preform according to claim 5, characterized in that the point connection means (24) of the warp (18) and weft (20) tapes/filaments are arranged at the intersection of said warp (18) and weft (20) tapes/filaments.

7. A method for producing a 3D preform by implementing the device according to claim 1, characterized in that it comprises the following steps:
arranging at least two warp tapes/filaments (18), in a first plane,
arranging at least one weft tape/filament (20) in a second plane, perpendicular to the first plane, each tape/filament being introduced between the warp tapes/filaments (18),
guiding and displacing each warp tape/filament (18) over a given length in the first plane, and according to a given profile of the warp tapes/filaments, in the second plane,
guiding and displacing each weft tape/filament (20), in the second plane, over a given length following said profile, between the warp tapes/filaments (18).

8. The method for producing a 3D preform according to claim 7, characterized in that it consists in arranging the at least two warp tapes/filaments (18) on either side of the given profile, alternately, having a passage between said warp tapes/filaments (18) for introduction of at least one weft tape/filament (20) between said at least two warp tapes/filaments (18).

9. The method for producing a 3D preform according to claim 8, characterized in that it consists in ensuring the connection of the warp tapes/filaments (18) and the weft tapes/filaments (20), as the warp tapes/filaments (18) advance, according to the given profile.

10. A 3D preform obtained by the production method according to claim 7, using the device according to any of claim 1, characterized in that it comprises warp tapes/filaments (18) and weft tapes/filaments (20) of different lengths, and at least one point connection between a warp tape/filament (18) and a weft tape/filament (20).
